(19) United States
(12) Patent Application Publication
(10) Pub. No.: US 2026/0100425 A1
(43) Pub. Date: Apr. 9, 2026

(54) RECHARGEABLE BATTERY AND ELECTROLYSIS METHOD OF MAKING THE SAME

(71) Applicant: Pure Lithium Corporation, Charlestown, MA (US)

(72) Inventors: Emilie BODOIN, Boston, MA (US); Donald R. SADOWAY, Boston, MA (US)

(21) Appl. No.: 19/242,699

(22) Filed: Jun. 18, 2025

Related U.S. Application Data
(63) Continuation-in-part of application No. 17/740,146, filed on May 9, 2022, now abandoned.
(63) Continuation-in-part of application No. 17/738,798, filed on May 6, 2022, now Pat. No. 12,412,897.
(60) Provisional application No. 63/187,688, filed on May 12, 2021.
(60) Provisional application No. 63/187,688, filed on May 12, 2021.

(51) Int. Cl. H01M 10/42; H01M 4/02; H01M 4/04; H01M 4/38; H01M 4/58; H01M 10/052; H01M 10/056

(52) U.S. Cl. CPC H01M 10/4235; H01M 4/0452; H01M 4/382; H01M 4/5815; H01M 10/052; H01M 10/056; H01M 2004/027; H01M 2300/0065

(57) ABSTRACT

A block or graft copolymer coated lithium metal electrode provides the negative electrode and the solid electrolyte for a rechargeable lithium metal battery that further includes a positive electrode. The copolymer coated lithium metal electrode may be manufactured by a process involving electroplating lithium metal through a copolymer coated conductive substrate, for which the copolymer coated conductive substrate has been prepared by coating the conductive substrate in a copolymer solution followed by evaporating the solvent. Alternatively, a lithium metal electrode may be coated directly with copolymer.

### CROSS-REFERENCE

This application is a continuation-in-part application of Ser. No. 17/740,146, filed May 9, 2022, and Ser. No. 17/738,798, filed May 6, 2022, each of which is incorporated herein by reference in its entirety. The application Ser. No. 17/740,146, filed May 9, 2022, claims the benefit of U.S. Provisional Application No. 63/187,688, filed May 12, 2021. The application Ser. No. 17/738,798, filed May 6, 2022, claims the benefit of U.S. Provisional Application No. 63/187,688, filed May 12, 2021.

### BACKGROUND

The present disclosure relates to the manufacture of lithium metal rechargeable batteries using polymeric solid-state electrolytes. The resultant batteries are safer and have increased cycle life compared to lithium metal batteries manufactured by conventional methods.

### SUMMARY

According to some embodiments a lithium metal electrode is disclosed, the lithium metal electrode including a conductive substrate, a layer of lithium metal coating the conductive substrate, the layer of lithium metal having an inner face and an outer face, the inner face contacting the conductive substrate, wherein the layer of lithium metal has no more than five ppm of non-metallic elements by mass. In some embodiments, the layer of lithium metal has no more than one ppm of non-metallic elements by mass. In some embodiments, a lithium ion conductive conformable polymer coats the outer face of the layer of lithium metal, the lithium ion conductive conformable polymer being configured to selectively allow lithium ions to electrophorese through the polymer under an applied voltage when the lithium metal electrode is immersed in a solution containing a lithium salt dissolved in a solvent.

In some embodiments, the solvent is likewise unable to pass through the lithium ion conductive conformable polymer to make contact with the layer of lithium metal. In some such embodiments, the solvent is water.

In some embodiments, the lithium ion conductive conformable polymer is a block or graft copolymer, with microphase separated first domains and second domains, each domain above its respective glass transition temperature, T_{g}, the first domains formed from first segments, the first segments configured to solvate lithium ions and to provide continuous conductive pathways for the transport of lithium ions and the second domains formed from second segments immiscible with the first segments. In some embodiments the first segments comprise poly(oxyethylene)n side chains, where n is an integer between 4 and 20.

In some embodiments the lithium ion conductive conformable polymer is a block copolymer. For some such block copolymers, the second segments comprise poly(alkyl methacrylate). In some embodiments, the block copolymer is poly[(oxyethylene)₉ methacrylate]-b-poly(butyl methacrylate) (POEM-b-PBMA). For some such embodiments, the ratio of POEM to PBM is between 55:45 and 70:30 on a molar basis.

In some embodiments the lithium ion conductive conformable polymer is a graft copolymer. For some such graft copolymers, the second segments comprise poly(dimethyl siloxane). According to some embodiments, the graft copolymer is poly[(oxyethylene)₉ methacrylate]-g-poly(dimethyl siloxane).

In accordance with embodiments of the present disclosure, a rechargeable lithium metal battery is disclosed which includes a positive electrode and a negative electrode. The negative electrode has a conductive substrate coated with a layer of lithium metal, the layer of lithium metal having an inner face and an outer face, the inner face contacting the conductive substrate, the layer of lithium metal having no more than 5 ppm of non-metallic elements by mass. In some embodiments, the layer of lithium metal has no more than 1 ppm of non-metallic elements by mass. A lithium ion conductive conformable polymer coats the outer face of the layer of lithium metal, the lithium ion conductive conformable polymer being disposed between the negative electrode and the positive electrode. The lithium ion conductive conformable polymer selectively allows lithium ions to electrophorese under an applied voltage, and for some embodiments prohibits any solvent that is present from making contact with the layer of lithium metal. In some embodiments, the conformable polymer of the rechargeable lithium metal battery is in direct physical contact with both the layer of lithium metal and the positive electrode, and is configured to adjust to volume changes of the positive and negative electrodes so as to maintain direct physical contact with both the layer of lithium metal and the positive electrode, and to function as a solid state electrolyte during both charging and discharging of the rechargeable battery.

In some embodiments of the rechargeable lithium metal battery, the lithium ion conductive conformable polymer is a block or graft copolymer, with microphase separated first domains and second domains, each domain above its respective glass transition temperature, T_{g}, the first domains formed from lithium ion solvating segments and providing continuous conductive pathways for the transport of lithium ions and the second domains formed from second segments immiscible with the first segments.

In some embodiments of the present disclosure, a rechargeable lithium metal battery is disclosed, the battery having a positive electrode including elemental sulfur, a negative electrode having a conductive substrate coated with a layer of lithium metal, the layer of lithium metal having an inner face and an outer face, the inner face contacting the conductive substrate, and a lithium ion conductive conformable polymer coating the outer face of the layer of lithium metal, the lithium ion conductive conformable polymer being disposed between the negative electrode and the positive electrode. For such a rechargeable lithium metal battery, the lithium ion conductive conformable polymer selectively allows lithium ions to electrophorese through the polymer under an applied voltage but prohibits polysulfides from passing through the lithium ion conductive conformable polymer and making contact with the layer of lithium metal. In some embodiments, the lithium ion conductive conformable polymer prohibits any solvent that is present from making contact with the layer of lithium metal. In some embodiments the lithium ion conductive conformable polymer is a block or graft copolymer, with microphase separated first domains and second domains, each domain above its respective glass transition temperature, T_{g}, the first domains formed from first segments, the first segments configured to solvate lithium ions and to provide continuous conductive pathways for the transport of lithium ions and the second domains formed from second segments immiscible with the first segments. In some embodiments the conformable polymer is in direct physical contact with both the layer of lithium metal and the positive electrode and is configured to adjust to volume changes of the positive and negative electrodes to maintain direct physical contact with both the layer of lithium metal and the positive electrode, and to function as a solid state electrolyte during both charging and discharging of the rechargeable battery. In some embodiments the layer of lithium metal has no more than five ppm of non-metallic elements by mass.

In some embodiments of the present disclosure, a process for extracting lithium metal from a lithium salt solution is disclosed, the method including the steps of:
1. preparing an electrolytic cell with a cathode and an anode, and an electrolyte solution including a lithium salt and a solvent, interposed between the anode and the cathode, wherein the cathode is a first conductive substrate coated with a layer of lithium ion conductive conformable polymer;
2. applying a voltage across the cathode and the anode, thereby depositing a layer of lithium metal on the surface of the first conductive substrate, sandwiched between the first conductive substrate and the layer of lithium ion conductive conformable polymer, the layer of lithium ion conductive conformable polymer adjusting shape to maintain contact with the growing layer of lithium metal, thereby forming a lithium metal layer on the surface of the conductive substrate, sandwiched between the conductive substrate and the lithium ion conductive conformable polymer.

According to some aspects of the present disclosure, the above process is used to manufacture a lithium metal electrode coated with lithium ion conductive conformable polymer. For some such lithium metal electrodes, the lithium ion conductive conformable polymer is a block or graft copolymer, with microphase separated first domains and second domains, each domain above its respective glass transition temperature, T_{g}, the first domains formed from lithium ion solvating segments and providing continuous conductive pathways for the transport of lithium ions and the second domains formed from second segments immiscible with the first segments.

According to some embodiments of the process, the lithium ion conductive conformable polymer is a block or graft copolymer, with microphase separated first domains and second domains, each domain above its respective glass transition temperature, T_{g}, the first domains formed from lithium ion solvating segments and providing continuous conductive pathways for the transport of lithium ions and the second domains formed from second segments immiscible with the first segments. According to some embodiments of the process, the solvent is water. According to some embodiments, the solvent is a molten salt. According to some embodiments the anode includes lithium metal. According to some embodiments of the process, the electrolyte solution is continuously supplied by a flow cell.

In some embodiments, during the manufacturing process the contents of the electrolytic cell are covered by a blanketing atmosphere, the blanketing atmosphere having no more than 10 ppm of lithium reactive components on a molar basis.

According to some aspects of the present disclosure, a process is disclosed for purifying lithium metal, the process including the steps of:
1. configuring an electrolytic cell with a cathode and an anode, wherein the cathode is a conductive substrate, and wherein the anode comprises impure lithium metal;
2. separating and surrounding the cathode and the anode with a lithium ion conducting elastomer, the lithium ion conducting elastomer having lithium salt dispersed therein;
3. applying a voltage across the electrodes, causing the layer of impure lithium metal to decrease in thickness as a layer of purified lithium metal is electroplated on the surface of the conductive substrate, wherein the lithium ion conductive conformable polymer selectively allows lithium ions to electrophorese through the polymer under the applied voltage, wherein as lithium metal leaves the anode and plates onto the cathode, the lithium ion conducting elastomer adjusts shape to maintain contact with the layer of impure lithium metal and with the layer of purified lithium metal, and wherein the layer of purified lithium metal has a higher weight fraction of lithium metal than the layer of impure lithium metal.

In accordance with embodiments of the present disclosure, a rechargeable lithium metal battery is disclosed which includes a negative electrode, the negative electrode having a conductive substrate coated with a layer of lithium metal, the layer of lithium metal having an inner face and an outer face, the inner face contacting the conductive substrate. The disclosed rechargeable lithium metal battery further includes a positive electrode. In such embodiments, a lithium ion conductive copolymer functional as a solid electrolyte coats the outer face of the lithium metal on the negative electrode, the lithium ion conductive copolymer having microphase separated first domains and second domains, each domain above its respective glass transition temperature, Tg, the first domains formed from lithium ion solvating segments and providing continuous conductive pathways for the transport of lithium ions and the second domains formed from second segments immiscible with the first segments, the copolymer being selected from the group consisting of a block copolymer and a graft copolymer.

In such embodiments, the solid electrolyte is disposed between the negative electrode and the positive electrode and is in direct physical contact with both the layer of lithium metal and the cathode. The embodied rechargeable lithium metal battery further includes a lithium salt dispersed within the solid electrolyte. In such embodiments the lithium metal battery is configured to interact with an external circuit so that during discharge the layer of lithium metal decreases in thickness, and the copolymer coating conforms its shape to continue to cover the thinning layer of lithium metal, and to accommodate any volume changes that may occur at the positive electrode. In such embodiments, the lithium metal battery is further configured to interact with the external circuit so that during electrolytic recharging voltage applied across the external circuit causes the layer of lithium metal to grow in thickness, and the copolymer coating to adjust shape to continue to cover the growing layer of lithium metal, and to accommodate any volume changes that may occur at the positive electrode.

In some embodiments, the positive electrode of the rechargeable lithium metal battery includes elemental sulfur. In some embodiments, the lithium ion solvating segments comprise poly(oxyethylene)n side chains, where n is an integer between 4 and 20. In some embodiments, the copolymer is a block copolymer. In other embodiments, the copolymer is a graft copolymer.

In some embodiments of the present disclosure, a process is disclosed for manufacturing a lithium metal electrode coated with a lithium ion conductive copolymer, the process including the steps of:
1. Preparing a coating solution of a lithium salt and a graft or block copolymer in a cosolvent, the copolymer having first segments and second segments, each segment above its respective glass transition temperature, T_{g}, the first segments formed from lithium ion solvating groups and the second segments being immiscible with the first segments, wherein each segment of the block or graft copolymer is separately soluble in the cosolvent.
2. Coating a first conductive substrate with the coating solution.
3. Evaporating the cosolvent from the coated conductive substrate so that the first conductive substrate is coated with a first layer of the lithium ion conductive copolymer, the lithium ion conductive copolymer forming microphase separated first domains and second domains, the first domains formed from the first segments and providing continuous conductive pathways for transport of lithium ions and the second domains formed from the second segments.
4. Configuring an electrolytic cell with an anode.
5. Configuring the copolymer coated first conductive substrate as a cathode in the electrolytic cell, the electrolytic cell containing a lithium salt solution interposed between the anode and the copolymer coated first conductive substrate.
6. Applying a voltage across the first conductive substrate and the anode, causing a first layer of lithium metal to deposit on the surface of the first conductive substrate, sandwiched between the first conductive substrate and the first layer of lithium ion conductive copolymer coating, the first layer of lithium ion conductive copolymer coating adjusting shape to continue to cover the growing layer of lithium metal, thereby forming the lithium metal electrode coated with the first layer of lithium ion conductive copolymer.

In some embodiments, a lithium metal electrode is disclosed that is prepared according to these steps. In some embodiments, during the manufacturing process the contents of the electrolytic cell are covered by a blanketing atmosphere, the blanketing atmosphere having no more than 10 ppm of lithium reactive components on a molar basis.

In some embodiments of the process, the anode of the electrodeposition cell is prepared by the additional steps of depositing a second layer of lithium metal on a second conductive substrate coating the second layer of lithium metal with the coating solution evaporating the cosolvent from the coated second layer of lithium metal so that the second layer of lithium metal is coated with a second layer of lithium ion conductive copolymer, the lithium ion conductive copolymer forming microphase separated first domains and second domains, each domain above its respective glass transition temperature, T_{g}, the first domains formed from the first segments and providing continuous conductive pathways for the transport of lithium ions and the second domains formed from the second segments, thereby obtaining the anode comprising the second layer of lithium metal sandwiched between the second conductive substrate and the second layer of lithium ion conductive copolymer.

In some embodiments, a lithium metal electrode is disclosed that is prepared according to these additional steps.

In some embodiments, a lithium metal electrode is disclosed that is coated with a lithium ion conductive copolymer that is a block copolymer. In some embodiments, a lithium metal electrode is disclosed that is coated with a lithium ion conductive copolymer that is a graft copolymer.

In some embodiments, the lithium ion conductive copolymer has segments with poly(oxyethylene)n side chains, where n is an integer between 4 and 20. In some such embodiments, the lithium ion conductive copolymer further has segments of poly(alkyl methacrylate). In the copolymer each segment is above its respective glass transition temperature, T_{g}.

In some embodiments, the lithium conductive copolymer is a graft copolymer with main chain segments including poly(oxyethylene)n side chains, where n is an integer between 4 and 20, and branch segments including poly(dimethyl siloxane).

In some embodiments, the lithium ion conductive copolymer is poly[(oxyethylene)₉ methacrylate]-b-poly(butyl methacrylate) (POEM-b-PBMA). In some such embodiments, the ratio of POEM to PBMA is between 55:45 and 70:30 on a molar basis. In some embodiments, the lithium ion conductive copolymer is poly[(oxyethylene)₉ methacrylate]-g-poly(dimethyl siloxane).

In some embodiments, a process is disclosed for manufacturing a lithium metal electrode that includes the steps of:
1. Inserting a first conductive substrate as a cathode in an electrolytic cell.
2. Inserting a second conductive substrate coated with lithium metal as an anode in the electrolytic cell.
3. Providing a lithium ion conducting copolymer separating and surrounding the first conductive substrate and the anode, the lithium ion conductive copolymer being a graft or block copolymer with first segments and second segments, the first segments formed from lithium ion solvating groups and the second segments being immiscible with the first segments.
4. Applying a voltage across the conductive substrate and the anode, causing lithium metal to deposit on the surface of the first conductive substrate, the lithium ion conductive copolymer adjusting shape to cover a growing layer of lithium metal on the first conductive substrate, and a thinning layer of lithium metal on the second conductive substrate, thereby forming the lithium metal electrode comprising the first conductive substrate and the lithium metal coating the first conductive substrate, wherein the lithium metal on the first conductive substrate is more pure than the lithium metal on the second conductive substrate.

According to some embodiments of the present disclosure, a rechargeable lithium metal battery is disclosed that includes a positive electrode and a negative electrode, the negative electrode having a layer of lithium metal coated with a layer of lithium ion conductive copolymer, wherein the lithium ion conductive copolymer is disposed between the negative electrode and the positive electrode and is in direct physical contact with both the layer of lithium metal and the positive electrode. According to such embodiments, the lithium metal battery is configured so that during discharge the layer of lithium metal decreases in thickness, and the copolymer coating conforms its shape to continue to cover the thinning layer of lithium metal. Further, according to such embodiments, the lithium metal battery is configured so that during electrolytic recharging the layer of lithium metal grows in thickness, and the copolymer coating conforms its shape to continue to cover the growing layer of lithium metal.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings (“Fig.”, “Figs.”, “FIGURE.” or “FIGURES.” herein) of which:

FIG. 1 illustrates the structural features of block and graft copolymers.

FIG. 2 shows steps in manufacturing a rechargeable lithium metal battery with a copolymer coated lithium negative electrode according to embodiments of the present disclosure.

FIG. 3a provides a cross-sectional view of a copolymer coated conductive substrate prior to electroplating lithium metal onto the substrate according to embodiments of the present disclosure.

FIG. 3b provides a top view of a copolymer coated conductive substrate prior to electroplating lithium metal onto the substrate according to embodiments of the present disclosure.

FIG. 4a provides a cross-sectional view of the conductive substrate of FIGS. 3a and 3b after electroplating lithium metal onto the substrate to form a lithium metal layer sandwiched between the conductive substrate and the copolymer coating according to embodiments of the present disclosure.

FIG. 4b provides a top view of the conductive substrate of FIG. 4a according to embodiments of the present disclosure.

FIG. 5a provides a cross-sectional view of a lithium metal coated conductive substrate prior to coating with copolymer according to embodiments of the present disclosure.

FIG. 5b provides a top view of a lithium metal coated conductive substrate prior to coating with copolymer according to embodiments of the present disclosure.

FIG. 6a provides a cross-sectional view of the lithium metal coated conductive substrate of FIGS. 5a and 5b after coating with copolymer according to embodiments of the present disclosure.

FIG. 6b provides a top view of the lithium metal coated conductive substrate of FIGS. 5a and 5b after coating with copolymer according to embodiments of the present disclosure.

FIG. 7 shows an electrolytic cell suitable for manufacturing the copolymer coated lithium metal electrode according to embodiments of the present disclosure, prior to electroplating of lithium onto the conductive substrate. In this cell the lithium salt solution is replenished by the flow of lithium salt solution into the cell.

FIG. 8 shows the electrolytic cell of FIG. 7 following electroplating of lithium onto the conductive substrate.

FIG. 9 shows an electrolytic cell suitable for manufacturing the copolymer coated lithium metal electrode according to embodiments of the present disclosure, prior to electroplating of lithium onto the conductive substrate. In this cell lithium ion in the lithium salt solution is replenished by oxidation of lithium at the lithium positive electrode.

FIG. 10 shows the electrolytic cell of FIG. 9 following electroplating of lithium onto the conductive substrate.

FIG. 11 shows an electrolytic cell with a copolymer solid electrolyte suitable for electroplating lithium metal onto a conductive substrate according to embodiments of the present disclosure.

FIG. 12 shows the electrolytic cell of FIG. 11 following electroplating of lithium metal onto the conductive substrate.

FIG. 13 shows a cross-section of a rechargeable battery constructed with the polymer coated lithium metal electrode according to an embodiment of the present disclosure. The battery in this embodiment includes a single positive electrode.

FIG. 14 shows a cross-section of a rechargeable battery constructed with the polymer coated lithium metal electrode according to an embodiment of the present disclosure. The battery in this embodiment includes two positive electrodes.

FIG. 15 shows an exterior view of the rechargeable battery embodied in FIG. 11.

FIG. 16 shows an exterior view of the rechargeable battery embodied in FIG. 12.

FIG. 17 shows electron microscopy of a cross section of a conductive substrate spin-coated with graft copolymer poly[(oxyethylene)₉ methacrylate]-g-poly(dimethyl siloxane).

FIG. 18 shows the time dependence of voltage and current during cycling of a lithium metal battery manufactured according to embodiments of the present disclosure.

### DETAILED DESCRIPTION

Various embodiments will be described below in more detail with reference to the accompanying drawings. The following detailed descriptions are provided to assist the reader in gaining a comprehensive understanding of the methods, apparatuses, and/or systems described herein as well as modifications thereof. Accordingly, various modifications and equivalents of the methods, apparatuses, and/or systems described herein will be apparent to those of ordinary skill in the art. Descriptions of well-known functions and constructions may be omitted for increased clarity and conciseness.

Lithium ion batteries (LIBs) dominate the lithium battery market. LIBs contain no metallic lithium present as such. The negative electrode comprises a carbon host for neutral lithium which is contained therein. In the electrolyte and in the positive electrode lithium is present only as the ion. Such batteries are attractive for their high energy density compared to that of other rechargeable batteries and for their ability to operate over multiple charge/discharge cycles. In lithium metal batteries (LMBs) by contrast the negative electrode comprises metallic lithium, just as in lead-acid batteries the negative electrode comprises metallic lead. During discharge of an LMB, lithium metal dissociates to form lithium ions and electrons. The lithium ions migrate through the electrolyte to the positive electrode. The electrons flow through an external circuit where they power a device. As the LMB recharges, lithium ions are reduced back to lithium metal as electrons flow back into the negative electrode. Because LMBs have intrinsically higher capacity than LIBs, they are the preferred technology for primary batteries. Moreover, since LMBs can be manufactured in the fully charged state, they do not require the lengthy formation process needed for LIBs. However, poor cycle life, volumetric expansion, and safety concerns relating to shorts resulting from dendrite formation and the potential for violent combustion of the flammable organic electrolytes used in LMBs have limited their practical use as rechargeable batteries.

Lithium metal batteries using sulfur as the positive electrode offer higher specific capacity than the lithium intercalation compounds that currently dominate the market. However, complex polysulfide species produced upon the reduction of elemental sulfur are soluble in the organic electrolytes typically used in lithium batteries, resulting in reduced cycle life due to the “polysulfide shuttle” effect.

A novel rechargeable lithium metal battery and methods to produce the same are needed to improve the cycle life and enhance the safety profile of rechargeable lithium metal batteries, in particular lithium metal batteries using elemental sulfur in the positive electrode.

### Definitions

Unless defined otherwise, all terms of art, notations and other technical and scientific terms or terminology used herein are intended to have the same meaning as is commonly understood by one of ordinary skill in the art to which the claimed subject matter pertains. In some cases, terms with commonly understood meanings are defined herein for clarity and/or for ready reference, and the inclusion of such definitions herein should not necessarily be construed to represent a substantial difference over what is generally understood in the art.

Throughout this application, various embodiments may be presented in a range format. It should be understood that the description in range format is merely for convenience and brevity and should not be construed as an inflexible limitation on the scope of the disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

As used in the specification and claims, the singular forms “a”, “an” and “the” include plural references unless the context clearly dictates otherwise. For example, the term “a sample” includes a plurality of samples, including mixtures thereof.

As used herein, the term “about” a number refers to that number plus or minus 10% of that number. The term “about” a range refers to that range minus 10% of its lowest value and plus 10% of its greatest value.

As used in this description and the accompanying claims, the following terms shall have the meanings indicated, unless the context otherwise requires:

A “solid electrolyte” is solid material at room temperature which allows ion transport between electrodes of an electrolytic or galvanic cell.

As used herein, a “conformable polymer” is an amorphous viscoelastic polymer above its glass transition temperature, capable of extensive molecular rearrangement, allowing the polymer to stretch and retract in response to macroscopic stress. When present as a coating on a substrate, such a conformable polymer can shrink and expand to adapt to volume changes of the substrate, while continuing to coat the substrate.

A “block copolymer” is a polymer with blocks made up of one monomer alternating with blocks of another monomer along a linear polymer strand.

A “graft copolymer” is a polymer which has a backbone strand made up of one type of monomer and branches of a second monomer.

A “segment” is a block for a block copolymer and a side chain or backbone for a graft copolymer.

“Microphase separation” of a block or graft copolymers occurs when polymer segments segregate into domains according to their monomeric units.

A “cosolvent” for different monomers is a solvent capable of dissolving each of the different segments of a block or graft copolymer.

A “common solvent” is identical with a “cosolvent.”

A “negative electrode” functions as an anode in a galvanic cell and as a cathode in an electrolytic cell.

A “positive electrode” functions as a cathode in a galvanic cell and as an anode in an electrolytic cell.

To “electrophorese”an ion is to transport the ion by means of an applied voltage.

The following abbreviations are used:
LiCF₃SO₃, lithium triflate;
LiFSI, lithium bis(fluorosulfonyl) imide;
LiTFSI, lithium bis(trifluoromethanesulfonyl) imide;
LiBOB, lithium bis(oxalate) borate;
LiF, lithium fluoride;
LiPF₆, lithium hexafluorophosphate; and
LiNO₃, lithium nitrate.

The tendency for lithium metal batteries to form dendrites can lead to electrical shorting. The common use of flammable organic electrolytes for such batteries exacerbates the potential of such shorts to lead to fires and explosions. Solid electrolytes have potential for eliminating these safety concerns by reducing dendrite formation and by avoiding the use of flammable organic electrolytes.

The ideal solid electrolyte has the ion transport properties of a liquid, the ability to preferentially transport desired ionic species, while blocking the transport of undesirable species. The ideal solid electrolyte has low flammability, and a resistance to dendrite formation. The ideal solid electrolyte has the mechanical properties of a solid, but can undergo molecular rearrangements to grow, to shrink, and to accommodate volume changes associated with positive and negative electrodes while still maintaining physical contact with both positive and negative electrodes.

Lithium sulfur (Li—S) batteries using sulfur as the positive electrode offer higher specific capacity than the lithium intercalation compounds that currently dominate the market. However, complex polysulfide species produced upon the reduction of elemental sulfur dissolve in the organic electrolytes typically used in lithium batteries, resulting in reduced cycle life due to the “polysulfide shuttle” effect.

Consequently, another desirable feature of a solid electrolyte for lithium metal batteries is the ability to block the “polysulfide shuttle” between the positive and negative electrodes that reduces battery performance and cycle life of Li—S batteries.

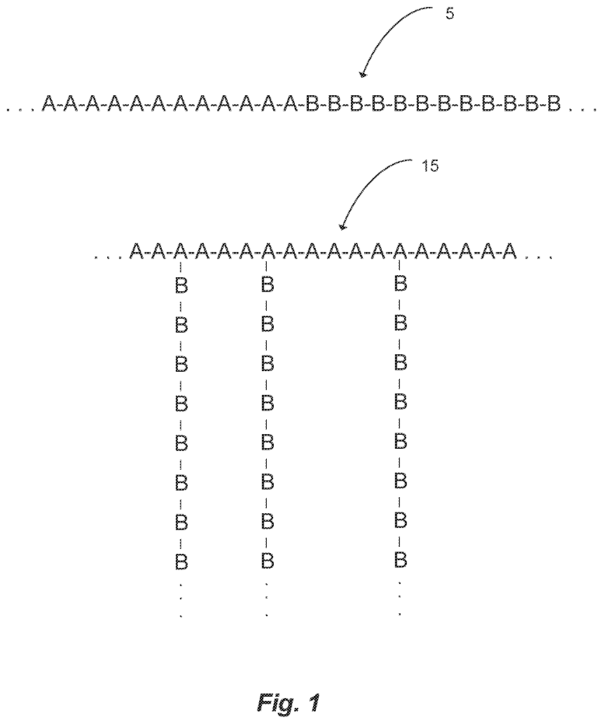

As illustrated in FIG. 1, block copolymers 5 of embodiments of the present disclosure have alternating blocks of monomer units, here designated by type “A” and type “B” monomers. In contrast graft copolymers 15 embodiments have a backbone made up of type “A” monomers and side-chains of type “B” monomers. The block copolymer 5 of FIG. 1 is a di-block polymer (AB) with one block of A and one block of B. In other embodiments, block copolymers can be tri-block (ABA or BAB) or multi-block copolymers.

Block copolymers with blocks of immiscible groups and graft copolymers with immiscible backbone and side-chain segments as embodied in this application provide a solid electrolyte with the ion transport properties of a liquid, and with the ability to preferentially transport desired ionic species, while blocking the transport of undesirable species. The thus embodied solid electrolyte has low flammability, and a resistance to dendrite formation. The thus embodied solid electrolyte has the mechanical properties of a solid, but can undergo molecular rearrangements to grow, to shrink, and to accommodate volume changes associated with positive and negative electrodes while still maintaining physical contact with both positive and negative electrodes.

Consequently, block copolymers with blocks of immiscible groups and graft copolymers with immiscible backbone and side-chain segments as embodied in this application provide a solid electrolyte technology for lithium metal batteries in general and Li—S batteries in particular, promising improved safety and performance, longer battery life, and a solution to the “polysulfide shuttle” problem. In short, block copolymers and graft copolymers as embodied in this application provide the key features of an ideal solid electrolyte for lithium metal batteries.

A block or graft copolymer as embodied in this application has one or more “A” segments of more hydrophilic lithium salt solvating polymers interspersed with one or more “B” segments of more hydrophobic polymers. All segments are above their respective glass transition temperatures, T_{g}. Material incorporating such a block or graft copolymer will microphase separate into locally segregated nanoscale domains of “A” and “B” segments. The resultant ordering of segments in turn confers conformational rigidity to the material even though all of the constituents are segmentally liquid. For suitable A:B ratios, the A segments form continuous lithium ion solvating channels. For lithium ion solvating segments having suitably high local chain mobility, high lithium conductivity allows the directed flow of lithium ions through the copolymer upon application of an electric field.

Dissolving the block or graft copolymer and a lithium salt in a suitable common solvent (cosolvent) that is capable of dissolving both A and B segments allows ready processing of the polymer with solvated lithium ions by conventional coating methods. For example, electrodes can be directly coated with a lithium ion conductive block or graft copolymer electrolyte by dipping the electrode in a solution of lithium salt and copolymer dissolved in cosolvent and allowing the cosolvent to evaporate. Such an electrode can then be directly used in a battery or electrolytic cell. In this manner, as described below, lithium metal electrodes can be coated with lithium ion conducting block or graft copolymer solid electrolytes for use in solid state batteries.

Suitable copolymers can be di-block copolymers (AB), tri-block copolymers (ABA or BAB), or higher multiblock polymers with alternating A and B blocks. All blocks are above their respective glass transition temperatures, T_{g}. Likewise suitable are graft copolymers with backbone A monomers and side-chain B monomers, or back-bone B monomers and side-chain A monomers. In some embodiments, the A segments incorporate short poly(oxyethylene)n side chains, where n, the number of oxyethylene groups in the side chain ranges from 4 to 20, preferably between 7 and 11. In some embodiments n is equal to nine. In some embodiments the poly(oxyethylene)n side chains are incorporated by polymerization of poly(oxyethylene)n methacrylate monomers. In a preferred embodiment, the A segments are synthesized by polymerization of poly(oxyethylene), methacrylate monomers.

In some embodiments, the B segments have alkyl side chains having from 3 to 6 carbons. In some embodiments, the B segments are synthesized from a poly(alkyl methacrylate). In some embodiments, the poly(alkyl methacrylate) is chosen from the group consisting of poly(propyl methacrylate), poly(butyl methacrylate), poly(pentyl methacrylate), and poly(hexyl methacrylate). In a preferred embodiment, the poly(alkyl methacrylate) is poly(butyl methacrylate).

In some embodiments the “A” segments incorporate a mixture of neutral and anionic groups. In some such embodiments, the anionic groups are configured in order to minimize coordination of the anionic groups with lithium cations.

In a particularly preferred embodiment, the copolymer is the di-block copolymer poly[(oxyethylene)₉ methacrylate]-b-poly(butyl methacrylate) (POEM-b-PBMA).

In some embodiments, the block copolymers are synthesized by living anionic polymerization. In some embodiments, the block copolymers are synthesized by atom transfer radical polymerization (ATRP).

In some embodiments, the copolymer is a graft copolymer with a hydrophilic backbone of “A” segments that are lithium salt solvating and hydrophobic side-chains of “B” segments made up of hydrophobic polymers. Each segment is above its respective glass transition temperature, T_{g}.

In a preferred embodiment, the copolymer is a graft copolymer with backbone “A” segments incorporating short poly(oxyethylene)n side chains, where n, the number of oxyethylene groups in the side chain ranges from 4 to 20, preferably between 7 and 11. In some embodiments, n is equal to nine. In some embodiments, the poly(oxyethylene)n side chains are incorporated by polymerization of poly(oxyethylene)n methacrylate monomers. In a preferred embodiment, the A segments are synthesized by polymerization of poly(oxyethylene)₉ methacrylate monomers.

In some embodiments, the polymer is a graft copolymer with side chain “B” segments incorporating poly(dimethyl siloxane) (PDMS). In a preferred embodiment, the graft copolymer is incorporated into a poly(oxyethylene)n methacrylate backbone by random copolymerization of poly(dimethyl siloxane) monomethacrylate macromonomer (PDMSMA) with poly(oxyethylene)ₙ methacrylate monomers to form a graft copolymer of type POEM-g-PDMS. In preferred embodiments, poly(oxyethylene)₉ methacrylate monomers are reacted to form the POEM-g-PDMS copolymer.

In some embodiments, the “A” backbone includes additional monomers. In some embodiments the additional monomers are anionic. In an embodiment, poly(oxyethylene)₉ methacrylate monomers are copolymerized with methacrylate monomers (MAA) and with PDMSMA to form poly(oxyethylene)₉-ran-MAA-g-PDMS. In a preferred embodiment, the carboxylic acid groups of this polymer are reacted with BF₃ to give anionic boron trifluoride esters, which have a reduced tendency to complex lithium ions when compared with MAA carboxylate groups.

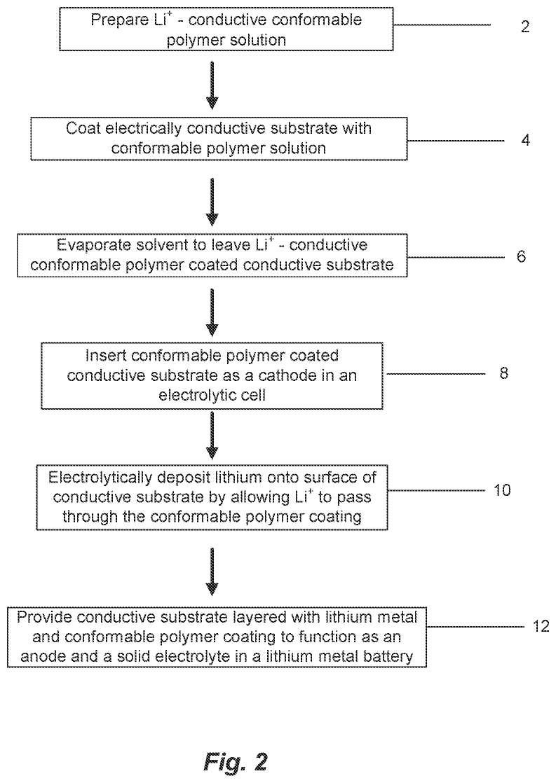

As summarized by the manufacturing steps shown in FIG. 2, in some embodiments, a copolymer coated lithium metal electrode is manufactured and inserted into a cell to function as a negative electrode (the metal) and a solid electrolyte (the polymer) in a lithium metal battery.

The steps of this embodiment are as follows: First, prepare a solution of lithium ion salt and block or graft copolymer in a cosolvent capable of dissolving both A and B segments of the copolymer 2. Second, coat an electrically conductive substrate with lithium salt doped copolymer by dipping the substrate in the lithium salt and copolymer solution 4. Third, evaporate the cosolvent to leave the electrolytically conductive substrate coated with lithium ion conductive copolymer 6. Next, insert the lithium ion conductive copolymer-coated conductive substrate as a cathode in an electrolytic cell, the electrolytic cell including an anode and a lithium salt solution 8. Then, apply voltage across the anode and the substrate, acting as a cathode, causing electrons to flow from the anode through an external circuit to the conductive substrate, causing lithium ions to be pulled through the copolymer coating, to be reduced at the substrate surface, thereby electrolytically plating lithium metal onto the surface 10. As lithium metal plates, the polymer chains of the copolymer coating undergo a molecular rearrangement, allowing the copolymer coating to continue to cover the growing layer of lithium metal, resulting in a final product for which the substrate is coated with a layer of lithium metal, and the layer of lithium metal is in turn coated with a layer of copolymer solid electrolyte. In the final step, the conductive substrate layered with lithium metal and a copolymer solid electrolyte is inserted as the combined lithium metal negative electrode and solid electrolyte in a lithium metal battery 12.

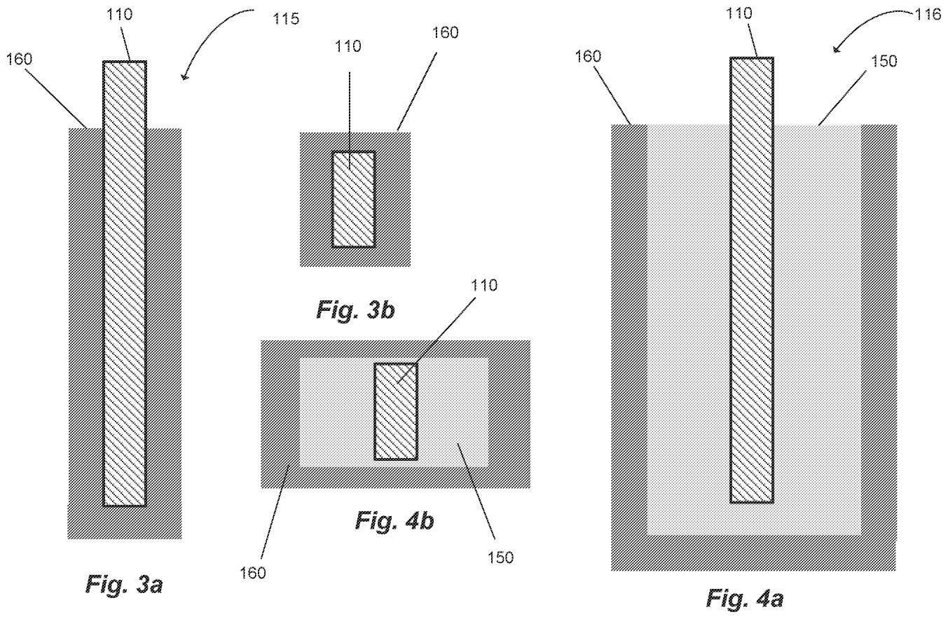

FIG. 3a shows a cross-section and FIG. 3b shows a top view of a copolymer coated electrically conductive substrate 115 according to embodiments of the present disclosure. Following the process of dipping the electrically conductive substrate 110 into a cosolvent solution of lithium salt and copolymer and drying, the centrally located electrically conductive substrate 110 is surrounded by a layer of copolymer solid electrolyte 160. FIG. 4a shows a cross-section and FIG. 4b shows a top view of the copolymer coated lithium metal electrode 116 that can be obtained following the electrolytic plating onto the electrically conductive substrate 110 of a layer of lithium metal 150 which fills the space between the conductive substrate 110 and the copolymer solid electrolyte 160.

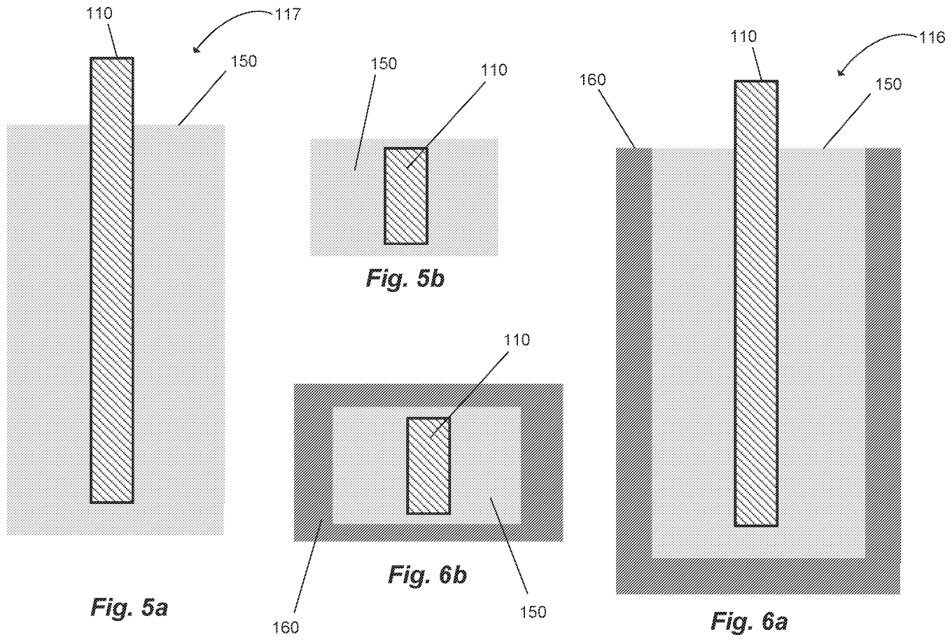

In the embodiment shown in FIGS. 5a, 5b, 6a, and 6b, the copolymer coated lithium metal electrode 116 can be obtained by first preparing, by electroplating or by other means, a lithium plated conductive substrate 117, then dipping the lithium plated substrate in a cosolvent solution of copolymer and drying the lithium plated substrate to obtain a copolymer coated negative electrode 115. FIG. 5a shows a cross-section and FIG. 5b shows a top view of a lithium coated conductive substrate 117 prior to coating with the copolymer solid electrolyte 160. FIG. 6a shows a cross-section and FIG. 6b shows a top view of the copolymer coated lithium metal electrode 116 after coating the lithium coated conductive substrate 117 with the copolymer solid electrolyte.

In preferred embodiments, the lithium metal in the copolymer coated lithium metal electrode 116 is ultrapure, having no more than five ppm of non-metallic elements by mass. In some embodiments, the lithium metal in the copolymer coated lithium metal electrode 116 includes no more than one ppm of non-metallic elements by mass. In some embodiments the lithium coated conductive substrate 117 is manufactured by methods described in U.S. patent applications Ser. No. 17/006,048 and Ser. No. 17/006,073, both of which were filed Aug. 28, 2020, and are incorporated by reference herein in their entirety.

In preferred embodiments, the conductive substrate is selected from the group consisting of copper, aluminum, graphite coated copper, and nickel. In some embodiments, the copolymer is (POEM-b-PBMA). In some embodiments, the ratio of POEM to PBMA is greater than 50:50 on a molar basis. In preferred embodiments, the ratio of POEM to PBMA is between 55:45 and 70:30 on a molar basis. In a preferred embodiment, the cosolvent is tetrahydrofuran (THF).

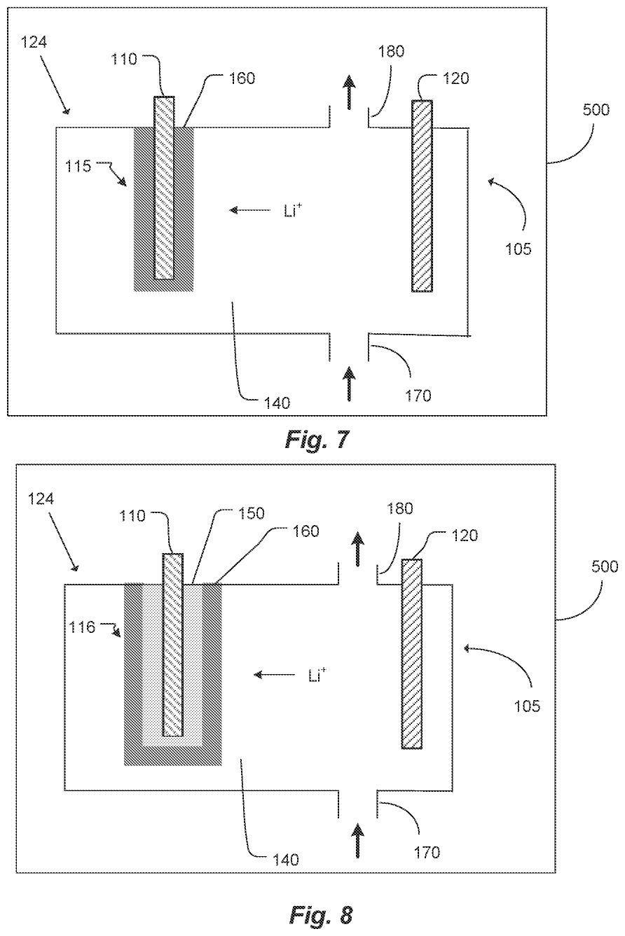

An embodiment of an electrolytic cell 105 for electroplating the electrically conductive substrate 110 with a layer of lithium metal 150 sandwiched between the conductive substrate 110 and the copolymer coating 160 is shown in FIG. 7 (before electroplating) and FIG. 8 (after electroplating). In manufacturing the copolymer coated lithium metal electrode 116, the copolymer coated electrically conductive substrate 115 is positioned as the cathode in the electrolytic cell 105. As shown in FIG. 7, the electrolytic cell 105 contains an anode 120 and a lithium salt solution 140 in contact with the anode 120 and with the copolymer 160 coating the conductive substrate 110.

In some embodiments, the electrolytic cell 105 is configured as a flow chamber, with an entrance port 170 and an exit port 180 allowing lithium salt solution 140 to enter the electrolytic cell 105 to provide a renewable supply of lithium ions for electroplating. In some embodiments, the electrolytic cell is completely blanketed with a blanketing atmosphere 124, the blanketing atmosphere being substantially free of lithium reactive components. In a preferred embodiment, the blanketing atmosphere includes no more than 10 ppm of lithium reactive components on a molar basis. In a preferred embodiment, the blanketing atmosphere includes no more than 5 ppm of lithium reactive components on a molar basis. In a preferred embodiment, the blanketing atmosphere includes no more than 10 ppm of nitrogen on a per molar basis. In a preferred embodiment, the blanketing atmosphere includes no more than 5 ppm of nitrogen on a per molar basis. In a preferred embodiment, the blanketing atmosphere includes no more than 1 ppm of nitrogen on a per molar basis. In a preferred environment, the blanketing atmosphere comprises argon with a purity of greater than 99.998 weight percent. In a preferred embodiment the blanketing atmosphere 124 and the electrolytic cell 105 are enclosed in a gas-impermeable container 500.

As shown in FIG. 8, in some embodiments, during electroplating a voltage is applied across the anode 120 and the conductive substrate 110 of the electrolytic cell 105, causing electrons to flow through an external circuit to the conductive substrate 110 and pulling lithium ions from the lithium salt solution 140 through the copolymer 160 to plate onto the surface of the conductive substrate, forming a layer of lithium metal 150 sandwiched between the conductive substrate 110 and the copolymer 160. As the layer of lithium metal 150 grows, the copolymer 160 undergoes molecular rearrangement, maintaining contact with the surface of the layer of lithium metal 150. In the process, a copolymer coated lithium metal electrode 116 is manufactured.

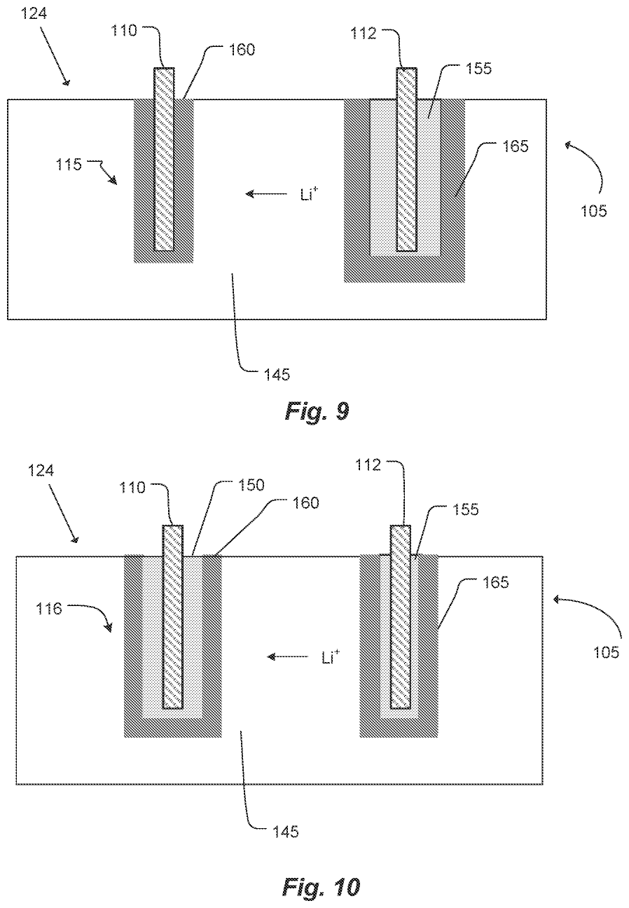

As shown in FIGS. 9 and 10, in some embodiments, the electrolytic cell 105 includes a negative electrode comprising a first conductive substrate 110 coated with copolymer 160, to be electroplated with a first layer of lithium metal 150, and a positive electrode 120 with a second conductive substrate 112 in physical contact with a second layer of lithium metal 155, the second layer of lithium metal 155 coated with copolymer 165. As voltage is applied across the electrodes, the second layer of lithium metal 155 releases lithium ions through the copolymer coating into the lithium salt solution 145, replenishing the supply of lithium ions as electroplating of lithium metal occurs on the surface of the first conductive substrate 110. Consequently, as shown in FIG. 10, as the layer of lithium metal 150 sandwiched between the first conductive substrate 110 and the copolymer 160 increases in thickness, the second layer of lithium metal 155 sandwiched between the second conductive substrate 112 and the copolymer 165 decreases in thickness.

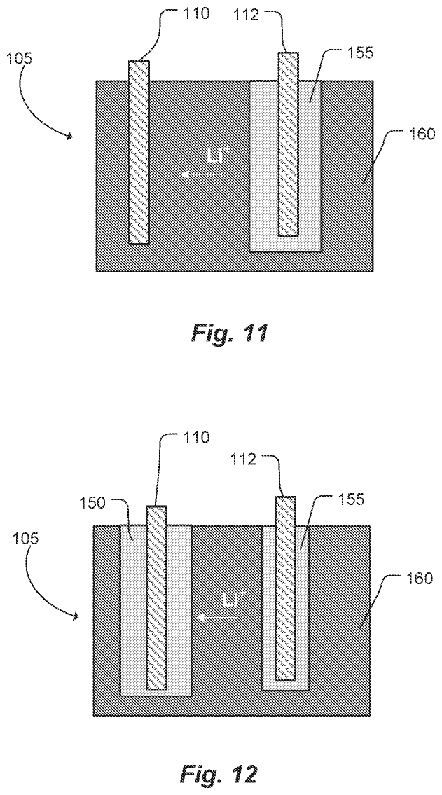

In the embodiment of FIGS. 11 and 12, an electrolytic cell 105 includes a first conductive substrate 110 functioning as a cathode, and an anode made of a second conductive substrate 112 coated with impure lithium 155. Separating and surrounding the two electrodes is a lithium ion conducting copolymer 160. Lithium salt is dispersed in the lithium ion conducting copolymer. As voltage is applied across the electrodes, electrons flow through an external circuit from the second conductive substrate to the first conductive substrate 110, causing the second layer of lithium metal 155 to release lithium ions, which flow through the lithium ion conducting copolymer 160 to the first conductive substrate, where they are reduced, electroplating lithium metal 150 on the surface of the first conductive substrate 110. Consequently, as shown in FIG. 12, as the first layer of lithium metal 150 on the first conductive substrate 110 increases in thickness, the second layer of lithium metal on the second conductive substrate 112 decreases in thickness. As lithium metal leaves the anode and travels to the cathode, the lithium ion conducting copolymer undergoes molecular rearrangement to maintain contact with the first layer of lithium metal 150 and second layer of lithium metal 155.

An advantage of the embodiments of FIGS. 9-12 is that the electroplated first layer of lithium metal 150 will be of higher purity and will have a smoother surface than the electroplating second layer of lithium metal 155. The method thus provides a straightforward means of obtaining higher purity, microscopically smoother lithium metal electrodes to use in lithium metal batteries, starting with lower purity, microscopically rougher lithium metal.

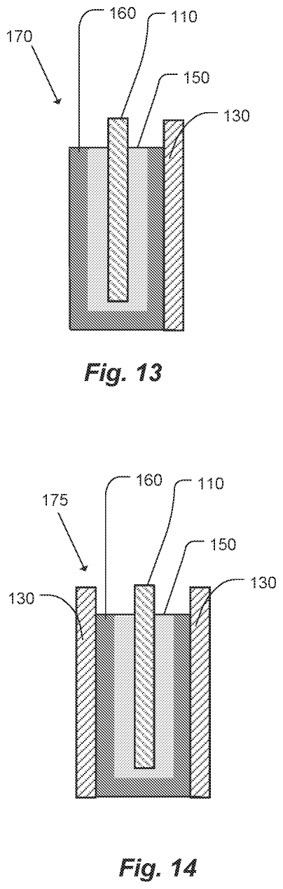

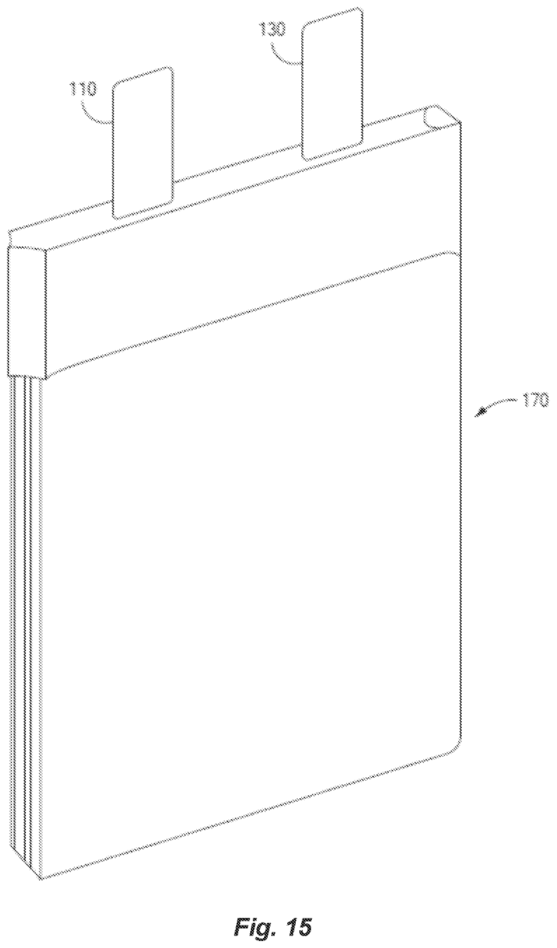

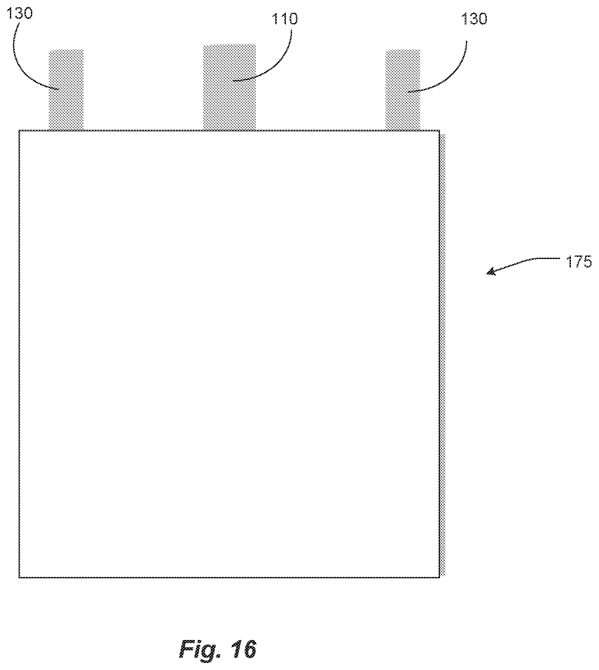

The copolymer coated lithium metal electrode 116, prepared by electrolytic or other methods, can be inserted directly into a rechargeable lithium battery, shown in cross-section in FIGS. 13 and 14, with exterior views in FIGS. 15 and 16, respectively.

In the battery embodied in FIGS. 13 and 15, a single positive electrode 130 is directly juxtaposed against the outer layer of copolymer 160 coating the negative electrode, to form a rechargeable battery 170 with the copolymer 160 providing the solid state electrolyte.

In the battery embodied in FIGS. 14 and 16, two positive electrodes 130 are directly juxtaposed against two sides of the outer layer of copolymer 160 coating the negative electrode, to form a rechargeable battery 175 with the copolymer 160 providing the solid state electrolyte.

In preferred embodiments of the batteries of FIGS. 13-16 , a lithium salt is dispersed within the copolymer. In some embodiments, the lithium salt is LiCF₃SO₃. In some embodiments LiCF₃SO₃ is dispersed within the copolymer at a molar ratio of between 50:1 and 10:1 ethylene oxide to lithium ion. In a preferred embodiment, the LiCF₃SO₃ is dispersed within the copolymer at a molar ratio of 20:1 ethylene oxide to lithium ion. In some embodiments, the copolymer with dispersed lithium salt coating the negative electrode is formed by solution casting directly from anhydrous THF.

In some embodiments the rechargeable batteries of FIGS. 13-16 are Li—S batteries, for which the positive electrode includes elemental sulfur. In preferred embodiments, the sulfur in the positive electrode is associated with a conductive matrix, enabling suitably high electron conductivity.

Li—S batteries constructed in the manner of FIGS. 13-16 enable Li⁺ transport, but block the transport of anions, including in particular polysulfide anions. Consequently, the polysulfide shuttle responsible for reducing the performance and cycle life of Li—S batteries is vitiated.

According to an embodiment of the present disclosure, a layer of a conformable polymer, doped with lithium salts, may approach ideal solid electrolyte behavior. In such an embodiment, the conformable polymer layer acts selectively to allow the electrophoresis of lithium ions while blocking the electrophoresis of other ions. According to some embodiments, solvent is also blocked from transporting through the conformable polymer layer. According to some embodiments, the conformable polymer is a block or graft copolymer.

As illustrated in FIG. 1, conformable block copolymers 5 of embodiments of the present disclosure have alternating blocks of monomer units, here designated by type “A” and type “B” monomers. In contrast graft copolymer 15 embodiments have a backbone made up of type “A” monomers and side-chains of type “B” monomers. The block copolymer 5 of FIG. 1 is a di-block polymer (AB) with one block of A and one block of B. In other embodiments, block copolymers can be tri-block (ABA or BAB) or multi-block copolymers.

Block copolymers with blocks of immiscible groups and graft copolymers with immiscible backbone and side-chain segments as embodied in this application are conformable polymers that provide a solid electrolyte with the ion transport properties of a liquid, and with the ability to preferentially transport desired ionic species, while blocking the transport of undesirable species. The thus embodied solid electrolyte has low flammability, and a resistance to dendrite formation. The thus embodied solid electrolyte has the mechanical properties of a solid, but can undergo molecular rearrangements to grow, to shrink, and to accommodate volume changes associated with positive and negative electrodes while still maintaining physical contact with both positive and negative electrodes.

Consequently, conformable polymers with the ability to selectively electrophorese lithium ions, including in particular block copolymers with blocks of immiscible groups and graft copolymers with immiscible backbone and side-chain segments as embodied in this application provide a solid electrolyte technology for lithium metal batteries in general and Li—S batteries in particular, promising improved safety and performance, longer battery life, and a solution to the “polysulfide shuttle” problem. In short, conformable polymers that selectively allow lithium ion transport, in particular block copolymers and graft copolymers as embodied in this application provide the key features of an ideal solid electrolyte for lithium metal batteries.

A lithium ion conducting conformable polymer comprising a block or graft copolymer as embodied in this application has one or more “A” segments of lithium salt solvating polymers interspersed with one or more “B” segments of polymers, the A and the B segments being immiscible with one another. All segments are above their respective glass transition temperatures, T_{g}. Material incorporating such a block or graft copolymer will microphase separate into locally segregated nanoscale domains of “A” and “B” segments. The resultant ordering of segments in turn confers conformational rigidity to the material even though all of the constituents are segmentally liquid. For suitable A:B ratios, the A segments form continuous lithium ion solvating channels. For lithium ion solvating chains having suitably high local chain mobility, high lithium conductivity allows the directed flow of lithium ions through the conformable polymer upon application of an electric field.

For some embodiments, both A and B segments are capable of lithium ion solvation, and lithium ion solvating channels can extend through both microphase separated regions.

Dissolving a lithium ion solvating conformable polymer and a lithium salt in a suitable solvent allows ready processing of the polymer by conventional coating methods. For conformable polymers that are block or graft copolymers, a suitable solvent is a cosolvent (common solvent) that is capable of dissolving both A and B segments as well as the lithium salt. In this manner, electrodes can be directly coated with lithium ion doped conformable polymer electrolyte by dipping the electrode in solution of the conformable polymer and a suitable lithium salt and allowing the solvent to evaporate. Alternatively, electrodes can be prepared by spin-coating an electrode with the solution of conformable polymer and lithium salt.

Such an electrode can then be directly used in a battery or electrolytic cell. In this manner, as described below, lithium metal electrodes can be coated with lithium ion conducting conformable polymers, including block or graft copolymer solid electrolytes for use in solid state batteries. Suitable lithium salts useful in preparing the lithium-doped, conformable polymer coated electrode include but are not limited to LiFSI, LiTFSI, LiBOB, LiF, LiPF₆, LiNO₃, and combinations thereof.

Block copolymers suitable as lithium ion conductive conformable polymers include di-block copolymers (AB), tri-block copolymers (ABA or BAB), or higher multiblock polymers with alternating A and B blocks, wherein all blocks are above their respective glass transition temperatures. In some embodiments, the A segments incorporate short poly(oxyethylene)ₙ side chains, where n, the number of oxyethylene groups in the side chain ranges from 4 to 20, preferably between 7 and 11. In some embodiments n is equal to nine. In some embodiments the poly(oxyethylene)ₙ side chains are incorporated by polymerization of poly(oxyethylene)ₙ methacrylate monomers. In a preferred embodiment, the A segments are synthesized by polymerization of poly(oxyethylene), methacrylate monomers.

In some embodiments, the B segments have alkyl side chains having from 3 to 6 carbons. In some embodiments, the B segments are synthesized from a poly(alkyl methacrylate). In some embodiments, the poly(alkyl methacrylate) is chosen from the group consisting of poly(propyl methacrylate), poly(butyl methacrylate), poly(pentyl methacrylate), and poly(hexyl methacrylate). In a preferred embodiment, the poly(alkyl methacrylate) is poly(butyl methacrylate).

In some embodiments the “A” segments incorporate a mixture of neutral and anionic groups. In some such embodiments, the anionic groups are configured in order to minimize coordination of the anionic groups with lithium cations.

In an embodiment, the conformable polymer is the di-block copolymer poly[(oxyethylene)₉ methacrylate]-b-poly(butyl methacrylate) (POEM-b-PBMA).

In some embodiments, the block copolymers are synthesized by living anionic polymerization. In some embodiments, the block copolymers are synthesized by atom transfer radical polymerization (ATRP).

In some embodiments, the conformable polymer is a graft copolymer with a backbone of “A” segments that are lithium salt solvating and side-chains of “B” segments that are immiscible with the “A” segments. Each segment is above its respective glass transition temperature.

In a preferred embodiment, the conformable polymer is a graft copolymer with backbone “A” segments incorporating short poly(oxyethylene)ₙ side chains, where n, the number of oxyethylene groups in the side chain ranges from 4 to 20, preferably between 7 and 11. In some embodiments, n is equal to nine. In some embodiments, the poly(oxyethylene)ₙ side chains are incorporated by polymerization of poly(oxyethylene)ₙ methacrylate monomers. In some embodiments, the A segments are synthesized by polymerization of poly(oxyethylene)₉ methacrylate monomers.

In some embodiments, the polymer is a graft copolymer with side chain “B” segments incorporating poly(dimethyl siloxane) (PDMS). In some embodiments, the graft copolymer is incorporated into a poly(oxyethylene)ₙ methacrylate backbone by random copolymerization of poly(dimethyl siloxane) monomethacrylate macromonomer (PDMSMA) with poly(oxyethylene)ₙ methacrylate monomers to form a graft copolymer of type POEM-g-PDMS. In preferred embodiments, poly(oxyethylene)₉ methacrylate monomers are reacted to form the POEM-g-PDMS copolymer.

In some embodiments, the “A” backbone includes additional monomers. In some embodiments the additional monomers are anionic. In an embodiment, poly(oxyethylene)₉ methacrylate monomers are copolymerized with methacrylate monomers (MAA) and with PDMSMA to form poly(oxyethylene)₉-ran-MAA-g-PDMS. In an embodiment, the carboxylic acid groups of this polymer are reacted with BF₃ to give anionic boron trifluoride esters, which have a reduced tendency to complex lithium ions when compared with MAA carboxylate groups.

As summarized by the manufacturing steps shown in FIG. 2, in some embodiments, a lithium metal electrode coated with a lithium ion conductive conformable polymer is manufactured and inserted into a cell to function as a negative electrode (the metal) and a solid electrolyte (the polymer) in a lithium metal battery.

The steps of this embodiment are as follows: First, prepare a solution of the lithium ion conductive conformable polymer in a solvent. If the conformable polymer is a block or graft copolymer, a suitable solvent is a cosolvent capable of dissolving both A and B segments 2. Second, coat an electrically conductive substrate with the conformable polymer, for example by dipping the substrate in the conformable polymer solution, or by spin-coating the substrate with the conformable polymer solution, or by some other coating method 4. Third, evaporate the solvent to leave the electrolytically conductive substrate coated with conformable polymer 6. Next, insert the conformable polymer-coated conductive substrate as a cathode in an electrolytic cell, the electrolytic cell including an anode and a lithium salt solution 8. Then, apply voltage across the anode and the substrate, acting as a cathode, causing lithium ions to selectively electrophorese through the copolymer coating, to be reduced at the substrate surface, thereby electrolytically plating lithium metal onto the surface 10. Because of the selective electrophoresis of lithium ions, other cations in solution are blocked from electrophoresisg to and electroplating on the substrate surface. As lithium metal plates, the conformable polymer coating deforms, allowing the conformable polymer coating to continue to cover the growing layer of lithium metal, resulting in a final product for which the substrate is coated with a layer of lithium metal, and the layer of lithium metal is in turn coated with a layer of conformable polymer solid electrolyte. In the final step, the conductive substrate layered with lithium metal and the conformable polymer solid electrolyte is inserted as the combined lithium metal negative electrode and solid electrolyte in a lithium metal battery 12.

FIG. 3a shows a cross-section and FIG. 3b shows a top view of a conformable polymer coated electrically conductive substrate 115 according to embodiments of the present disclosure. Following the process of coating the electrically conductive substrate 110 with a solvent solution of conformable polymer and drying, the centrally located electrically conductive substrate 110 is surrounded by a layer of conformable polymer solid electrolyte 160. FIG. 4a shows a cross-section and FIG. 4b shows a top view of the conformable polymer coated lithium metal electrode 116 that can be obtained following the electrolytic plating onto the electrically conductive substrate 110 of a layer of lithium metal 150 which fills the space between the conductive substrate 110 and the conformable polymer solid electrolyte 160.

In the embodiment shown in FIGS. 5a, 5b, 6a, and 6b, the conformable polymer coated lithium metal electrode 116 can be obtained by first preparing, by electroplating or by other means, a lithium plated conductive substrate 117, then dipping this substrate in or spin-coating this substrate with a conformable polymer solution and drying the lithium plated substrate to obtain a copolymer coated negative electrode 115. FIG. 5a shows a cross-section and FIG. 5b shows a top view of a lithium coated conductive substrate 117 prior to coating with the conformable polymer solid electrolyte 160. FIG. 6a shows a cross-section and FIG. 6b shows a top view of the conformable polymer coated lithium metal electrode 116 after coating the lithium coated conductive substrate 117 with the conformable polymer solid electrolyte.

In preferred embodiments, the lithium metal in the conformable polymer coated lithium metal electrode 116 is ultrapure, having no more than five ppm of non-metallic elements by mass. In some embodiments, the lithium metal in the conformable polymer coated lithium metal electrode 116 includes no more than one ppm of non-metallic elements by mass. Typical non-metallic elements that are effectively minimized include nitrogen, phosphorous, and fluorine. In some embodiments the lithium coated conductive substrate 117 is manufactured by methods described in U.S. patent applications Ser. No. 17/006,048 and Ser. No. 17/006,073, both of which were filed Aug. 28, 2020, and are incorporated by reference herein in their entirety. For such methods, the manufacturing process proceeds under a blanketing atmosphere having no more than 10 ppm of lithium reactive components on a molar basis. For example, the blanketing atmosphere may be an argon atmosphere, wherein the argon has a purity of greater than 99.998 weight percent. Notably, nitrogen is a common lithium reactive atmospheric component, reacting with lithium metal to form lithium nitride.

In preferred embodiments, the conductive substrate is selected from the group consisting of copper, aluminum, graphite coated copper, and nickel. In some embodiments, the solvent is tetrahydrofuran (THF).

In some embodiments, the conformable polymer is the block copolymer POEM-b-PBMA. In some embodiments, the ratio of POEM to PBMA is greater than 50:50 on a molar basis. In preferred embodiments, the ratio of POEM to PBMA is between 55:45 and 70:30 on a molar basis.

In some embodiments, the conformable polymer is the graft copolymer poly[(oxyethylene)₉ methacrylate]-g-poly(dimethyl siloxane).

An embodiment of an electrolytic cell 105 for electroplating the electrically conductive substrate 110 with a layer of lithium metal 150 sandwiched between the conductive substrate 110 and the conformable polymer coating 160 is shown in FIG. 7 (before electroplating) and FIG. 8 (after electroplating). In manufacturing the conformable polymer coated lithium metal electrode 116, the conformable polymer coated electrically conductive substrate 115 is positioned as the cathode in the electrolytic cell 105. As shown in FIG. 7, the electrolytic cell 105 contains an anode 120 and a lithium salt solution 140 in contact with the anode 120 and with the conformable polymer 160 coating the conductive substrate 110.

In some embodiments, the electrolytic cell 105 is configured as a flow chamber, with an entrance port 170 and an exit port 180 allowing lithium salt solution 140 to enter the electrolytic cell 105 to provide a renewable supply of lithium ions for electroplating. In some embodiments, the electrolytic cell is completely blanketed with a blanketing atmosphere 124, the blanketing atmosphere being substantially free of lithium reactive components. In a preferred embodiment, the blanketing atmosphere includes no more than 10 ppm of lithium reactive components on a molar basis. In a preferred embodiment, the blanketing atmosphere includes no more than 5 ppm of lithium reactive components on a molar basis. In a preferred embodiment, the blanketing atmosphere includes no more than 10 ppm of nitrogen on a per molar basis. In a preferred embodiment, the blanketing atmosphere includes no more than 5 ppm of nitrogen on a per molar basis. In some embodiments, the blanketing atmosphere includes no more than 1 ppm of nitrogen on a per molar basis. In a preferred environment, the blanketing atmosphere comprises argon with a purity of greater than 99.998 weight percent. In some embodiments the blanketing atmosphere 124 and the electrolytic cell 105 are enclosed in a gas-impermeable container 500.

According to embodiments of the present disclosure, by using the lithium ion selective membrane during electroplating and by using a blanketing atmosphere having less than 10 ppm of lithium reactive components, the goal is achieved of having less than 5 ppm, and in some cases less than 1 ppm of non-metallic impurities associated with the lithium layer, such non-metallic impurities including nitrogen, phosphorous, and fluorine.

As shown in FIG. 8, in some embodiments, during electroplating a voltage is applied across the anode 120 and the conductive substrate 110 of the electrolytic cell 105, causing electrons to flow through an external circuit to the conductive substrate 110 and pulling lithium ions from the lithium salt solution 140 into the conformable polymer layer, and causing the lithium ions to selectively electrophorese through the conformable polymer layer 160 to plate onto the surface of the conductive substrate, forming a layer of lithium metal 150 sandwiched between the conductive substrate 110 and the conformable polymer 160. As the layer of lithium metal 150 grows, the conformable polymer 160 molecular structure rearranges to maintain contact with the surface of the layer of lithium metal 150. In the process, a conformable polymer coated lithium metal electrode 116 is manufactured.

As shown in FIGS. 9 and 10, in a first embodied method of purifying lithium, the electrolytic cell 105 includes a negative electrode comprising a first conductive substrate 110 coated with conformable polymer 160, to be electroplated with a first layer of lithium metal 150, and a positive electrode 120 with a second conductive substrate 112 in physical contact with a second layer of lithium metal 155, the second layer of lithium metal 155 coated with conformable polymer 165. Separating the negative electrode and the positive electrode is a lithium salt solution 145. As voltage is applied across the electrodes, the second layer of lithium metal 155 releases lithium ions through the conformable polymer coating into the lithium salt solution 145, replenishing the supply of lithium ions as electroplating of purified lithium metal occurs on the surface of the first conductive substrate 110. Consequently, as shown in FIG. 10, as the layer of lithium metal 150 sandwiched between the first conductive substrate 110 and the conformable polymer 160 increases in thickness, the second layer of lithium metal 155 sandwiched between the second conductive substrate 112 and the conformable polymer 165 decreases in thickness.

In a second purification method, embodied in FIGS. 11 and 12, an electrolytic cell 105 includes a first conductive substrate 110 functioning as a cathode, onto which a first layer of lithium metal is to be plated, and an anode made of a second conductive substrate 112 coated with a second layer of lithium metal, the second layer of lithium metal 155 having impurities associated therewith. Separating the two electrodes is a lithium ion conducting conformable polymer 160. Lithium salt is dispersed in the lithium ion conducting conformable polymer. As voltage is applied across the electrodes, electrons flow through an external circuit from the second conductive substrate to the first conductive substrate 110, causing the second layer of lithium metal 155 to release lithium ions, which flow through the lithium ion conducting conformable polymer 160 to the first conductive substrate, where they are reduced, electroplating the first layer of lithium metal 150 on the surface of the first conductive substrate 110. Consequently, as shown in FIG. 12, as the first layer of lithium metal 150 on the first conductive substrate 110 increases in thickness, the second layer of lithium metal on the second conductive substrate 112 decreases in thickness. As lithium metal leaves the anode and plates onto the cathode, the lithium ion conducting conformable polymer adjusts shape to maintain contact with the first layer of lithium metal 150 and second layer of lithium metal 155.

An advantage of the two methods embodied in FIGS. 9-12 is that the electroplated first layer of lithium metal 150 will be of higher purity and will have a smoother surface than the electroplating second layer of lithium metal 155. The methods thus provide straightforward means of purifying lithium metal and of directly obtaining high purity, microscopically smooth lithium metal electrodes to use in lithium metal batteries, starting with lower purity, microscopically rougher lithium metal. When the two methods are performed under a blanketing atmosphere with less than 10 ppm of lithium reactive components, the level of both metallic and non-metallic impurities can be reduced.

The conformable polymer coated lithium metal electrode 116, prepared by electrolytic or other methods, can be inserted directly into a rechargeable lithium battery, shown in cross-section in FIGS. 13 and 14, with exterior views in FIGS. 15 and 16, respectively.

In the battery embodied in FIGS. 13 and 15, a single positive electrode 130 is directly juxtaposed against the outer layer of conformable polymer 160 coating the negative electrode, to form a rechargeable battery 170 with the conformable polymer 160 providing the solid state electrolyte.

In the battery embodied in FIGS. 14 and 16, two positive electrodes 130 are directly juxtaposed against two sides of the outer layer of conformable polymer 160 coating the negative electrode, to form a rechargeable battery 175 with the conformable polymer 160 providing the solid state electrolyte.

In embodiments of the batteries of FIGS. 13-16 , a lithium salt is dispersed within the conformable polymer. In some embodiments, the lithium salt is chosen from the group consisting of LiCF₃SO₃, LiFSI, LiTFSI, LiBOB, LiF, LiPF₆, LiNO₃, and combinations thereof. In some embodiments, the lithium salt is LiCF₃SO₃. In some embodiments LiCF₃SO₃ is dispersed within the conformable polymer at a molar ratio of between 50:1 and 10:1 ethylene oxide to lithium ion. In some embodiments, the LiCF₃SO₃ is dispersed within the conformable polymer at a molar ratio of 20:1 ethylene oxide to lithium ion. In some embodiments, the conformable polymer with dispersed lithium salt coating the negative electrode is formed by solution casting directly from anhydrous THF.

In some embodiments the rechargeable batteries of FIGS. 13-16 are Li—S batteries, for which the positive electrode includes elemental sulfur. In preferred embodiments, the sulfur in the positive electrode is associated with a conductive matrix, enabling suitably high electron conductivity.

Li—S batteries constructed in the manner of FIGS. 13-16 enable Li⁺ transport, but block the transport of anions, including in particular polysulfide anions. Consequently, the polysulfide shuttle responsible for reducing the performance and cycle life of Li—S batteries is vitiated.

The section headings used herein are for organizational purposes only and are not to be construed as limiting the subject matter described.

### EXAMPLES

The following examples are included for illustrative purposes only and are not intended to limit the scope of the present disclosure.

### Example 1: A Recyclable Battery With Conformable Graft Copolymer

A lithium metal battery was constructed using a copper substrate as the negative electrode, the copper substrate being spin-coated with a solution of 10% POEM-g-PDMS, dissolved in THF with LiTFSI added at an EO/Li ratio of 20. The positive electrode was an NMC electrode. The battery construction involved pressing together the spin coated copper substrate so that the positive and negative electrodes were separated by the POEM-g-PDMS, the POEM-g-PDMS providing a solid electrolyte for the battery.

In performing the spin coating, 50 microliters of the polymer solution were dropped onto a face of a cleaned, bare copper substrate, the face being a 1″ diameter circle. The copper substrate was attached to a spin coater, spun at 3,000 rpm and allowed to dry.

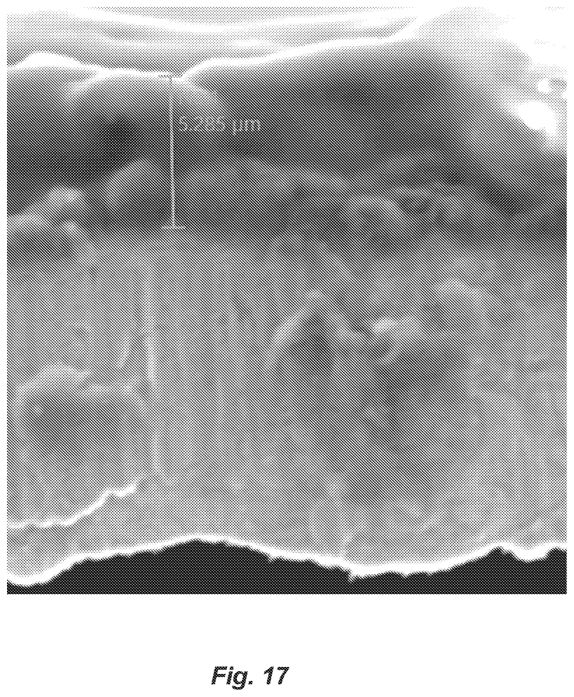

As shown in FIG. 17, the spin coating method provided an ultrathin coating of approximately 5 microns in depth over the surface of the copper substrate. The ultrathin coating has the advantage of reducing cost and decreasing cell overpotential.

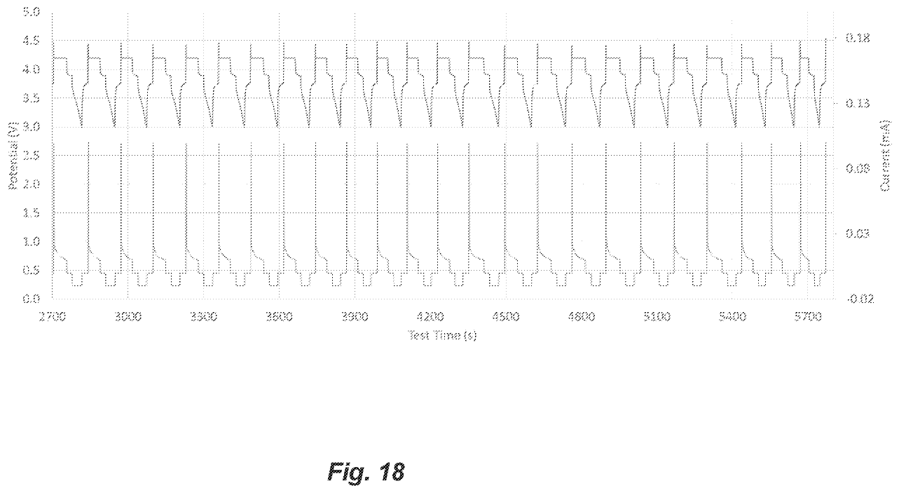

Surprisingly, as shown in FIG. 18, even with this ultrathin coating, the battery maintains consistent charge-discharge capacity over multiple cycles, with no noticeable degradation over the course of more than 100 cycles, with 24 representative cycles shown. Capacity remained consistent during the course of cycling.

The embodiments of the present disclosure described above are intended to be merely exemplary; numerous variations and modifications will be apparent to those skilled in the art. All such variations and modifications are intended to be within the scope of the present disclosure as defined in any appended claims.

While preferred embodiments of the present disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the disclosure. It is intended that the following claims define the scope of the disclosure and that methods and structures within the scope of these claims and their equivalents be covered thereby.

1. A rechargeable lithium metal battery comprising:
a negative electrode, the negative electrode having a conductive substrate coated with a layer of lithium metal, the layer of lithium metal having an inner face and an outer face, the inner face contacting the conductive substrate;
a positive electrode;
a solid electrolyte comprising a lithium ion conductive copolymer coating the outer face of the lithium metal, the lithium ion conductive copolymer having microphase separated first domains and second domains, each domain above its respective glass transition temperature, T_{g}, the first domains formed from lithium ion solvating segments and providing continuous conductive pathways for the transport of lithium ions and the second domains formed from second segments immiscible with the first segments, the copolymer being selected from the group consisting of a block copolymer and a graft copolymer; and
a lithium salt dispersed within the solid electrolyte;
wherein the solid electrolyte is disposed between the negative electrode and the positive electrode, and is in direct physical contact with both the layer of lithium metal and the cathode,
wherein the lithium metal battery is configured to interact with an external circuit so that during discharge:
the layer of lithium metal decreases in thickness, and the copolymer coating conforms its shape to continue to cover the thinning layer of lithium metal, and to accommodate any volume changes that may occur at the positive electrode,
wherein the lithium metal battery is configured to interact with the external circuit so that during electrolytic recharging:
a voltage applied across the external circuit causes the layer of lithium metal to grow in thickness, and the copolymer coating to adjust shape to continue to cover the growing layer of lithium metal, and to accommodate any volume changes that may occur at the positive electrode.

2. The rechargeable lithium metal battery of claim 1, wherein the positive electrode comprises elemental sulfur.

3. The rechargeable lithium metal battery of claim 1, wherein the lithium ion solvating segments comprise poly(oxyethylene)ₙ side chains, where n is an integer between 4 and 20.

4. The rechargeable lithium metal battery of claim 1, wherein the copolymer is a block copolymer.

5. The rechargeable lithium metal battery of claim 1, wherein the copolymer is a graft copolymer.

6. A process for manufacturing a lithium metal electrode coated with a lithium ion conductive copolymer, comprising:
preparing a coating solution of a lithium salt and a block or graft copolymer in a cosolvent, the copolymer having first segments and second segments, each segment above its respective glass transition temperature, T_{g}, the first segments formed from lithium ion solvating groups and the second segments being immiscible with the first segments, wherein each segment of the block or graft copolymer is separately soluble in the cosolvent;
coating a first conductive substrate with the coating solution;
evaporating the cosolvent from the coated conductive substrate so that the first conductive substrate is coated with a first layer of the lithium ion conductive copolymer, the lithium ion conductive copolymer forming microphase separated first domains and second domains, the first domains formed from the first segments and providing continuous conductive pathways for transport of lithium ions and the second domains formed from the second segments;
configuring an electrolytic cell with an anode;
configuring the copolymer coated first conductive substrate as a cathode in the electrolytic cell, the electrolytic cell containing a lithium salt solution interposed between the anode and the copolymer coated first conductive substrate;
applying a voltage across the first conductive substrate and the anode, causing a first layer of lithium metal to deposit on the surface of the first conductive substrate, sandwiched between the first conductive substrate and the first layer of lithium ion conductive copolymer coating, the first layer of lithium ion conductive copolymer coating adjusting shape to continue to cover the growing layer of lithium metal, thereby forming the lithium metal electrode coated with the first layer of lithium ion conductive copolymer.

7. The process according to claim 6, wherein the anode is prepared by a process comprising:
depositing a second layer of lithium metal on a second conductive substrate;
coating the second layer of lithium metal with the coating solution;
evaporating the cosolvent from the coated second layer of lithium metal so that the second layer of lithium metal is coated with a second layer of lithium ion conductive copolymer, the lithium ion conductive copolymer forming microphase separated first domains and second domains, the first domains formed from the first segments and providing continuous conductive pathways for transport of lithium ions and the second domains formed from the second segments, thereby obtaining the anode comprising the second layer of lithium metal sandwiched between the second conductive substrate and the second layer of lithium ion conductive copolymer.

8. A lithium metal electrode coated with lithium ion conductive copolymer manufactured according to the process of claim 6.

9. A lithium metal electrode coated with lithium ion conductive copolymer manufactured according to the process of claim 7.

10. The lithium metal electrode coated with lithium ion conductive copolymer of claim 8, wherein the lithium ion conductive copolymer is a block copolymer or a graft copolymer.

11. (canceled)

12. (canceled)

13. (canceled)

14. (canceled)

15. (canceled)

16. (canceled)

17. (canceled)

18. The lithium metal electrode coated with a lithium ion conductive copolymer of claim 8, wherein during the manufacturing process the contents of the electrolytic cell are covered by a blanketing atmosphere, the blanketing atmosphere having no more than 10 ppm of lithium reactive components on a molar basis.

19-41. (canceled)

42. A process for extracting lithium metal from a lithium salt solution, comprising:
preparing an electrolytic cell with a cathode and an anode, and an electrolyte solution including a lithium salt and a solvent, interposed between the anode and the cathode, wherein the cathode is a first conductive substrate coated with a layer of lithium ion conductive conformable polymer;
applying a voltage across the cathode and the anode, thereby depositing a layer of lithium metal on the surface of the first conductive substrate, sandwiched between the first conductive substrate and the layer of lithium ion conductive conformable polymer, the layer of lithium ion conductive conformable polymer adjusting shape to maintain contact with the growing layer of lithium metal, thereby forming a lithium metal layer on the surface of the conductive substrate, sandwiched between the conductive substrate and the lithium ion conductive conformable polymer,
wherein the lithium ion conductive conformable polymer selectively allows lithium ions to electrophorese through the polymer under the applied voltage.

43. The process of claim 42, wherein the lithium ion conductive conformable polymer is a block or graft copolymer, with microphase separated first domains and second domains, each domain above its respective glass transition temperature, T_{g}, the first domains formed from lithium ion solvating segments and providing continuous conductive pathways for the transport of lithium ions and the second domains formed from second segments immiscible with the first segments.

44. The process of claim 42, wherein the solvent is water.

45. The process of claim 42, wherein the solvent is a molten salt.

46. The process of claim 42, wherein the anode includes lithium metal.

47. The process of claim 42, wherein the electrolyte solution is continuously supplied by a flow cell.

48. The process of claim 42, wherein during the process for extracting lithium metal the contents of the electrolytic cell are covered by a blanketing atmosphere, the blanketing atmosphere having no more than 10 ppm of lithium reactive components on a molar basis.

49. A lithium metal electrode coated with lithium ion conductive conformable polymer, the lithium metal being extracted according to the process of claim 42.

50. The lithium metal electrode of claim 49, wherein the lithium ion conductive conformable polymer is a block or graft copolymer, with microphase separated first domains and second domains, each domain above its respective glass transition temperature, T_{g}, the first domains formed from lithium ion solvating segments and providing continuous conductive pathways for the transport of lithium ions and the second domains formed from second segments immiscible with the first segments.

51. (canceled)
